(19) United States
(12) Patent Application Publication
(10) Pub. No.: US 2024/0080357 A1
(43) Pub. Date: Mar. 7, 2024

(54) SYSTEM AND METHOD FOR PROACTIVE BLOCKING OF REMOTE DISPLAY PROTOCOL CONNECTION REQUESTS FROM SUSPICIOUS USERS AND DEVICES

(71) Applicant: Workspot, Inc., Campbell, CA (US)

(72) Inventors: Anushree Kunal Pole, Sunnyvale, CA (US); Jimmy Chang, Mountain View, CA (US); Virabrahma Prasad Krothapalli, San Jose, CA (US); Amitabh Bhuvangyan Sinha, San Jose, CA (US); David T. Sulcer, Pacifica, CA (US)

(21) Appl. No.: 18/095,838

(22) Filed: Jan. 11, 2023

Related U.S. Application Data
(60) Provisional application No. 63/374,442, filed on Sep. 2, 2022.

(51) Int. Cl. H04L 67/08; H04L 9/40

(52) U.S. Cl. CPC H04L 67/08; H04L 63/0236; H04L 63/102

(57) ABSTRACT

A virtual desktop system includes one or more virtual desktops and associated public cloud infrastructure. The system further includes a control plane coupled to the public cloud infrastructure. In response to a client device application operated by a user requesting the one or more virtual desktops, the control plane is triggered to obtain information associated with the user and/or information associated with the client device application. The control plane is further triggered to provide the obtained information to the public cloud infrastructure for storage. The public cloud infrastructure is configured to (a) compare usernames and/or IP addresses to the stored information associated with the user and/or the stored information associated with the client device, and (b) permit the user access to the one or more virtual desktops in response to the comparison of the usernames and/or IP addresses matching the stored information.

### PRIORITY CLAIM

This application claims priority to U.S. Provisional Application No. 63/374,442, filed on Sep. 2, 2022. The entirety of that application is hereby incorporated by reference.

### TECHNICAL FIELD

The present disclosure relates generally to network-based virtual desktop systems. More particularly, aspects of this disclosure relate to a system that provides a virtual desktop user dynamic access to one of multiple desktops.

### BACKGROUND

Computing systems that rely on applications operated by numerous networked computers are ubiquitous. Information technology (IT) service providers thus must effectively manage and maintain very large-scale infrastructures. An example enterprise environment may have many thousands of devices and hundreds of installed software applications to support. The typical enterprise also uses many different types of central data processors, networking devices, operating systems, storage services, data backup solutions, cloud services, and other resources. These resources are often provided by means of cloud computing, which is the on-demand availability of computer system resources, such as data storage and computing power, over the public internet or other networks without direct active management by the user.

Users of networked computers such as in a cloud-based system may typically log into a computer workstation or client device and are provided a desktop application that displays an interface of applications and data available via the network or cloud. Such desktop applications will be initially accessed when a user logs in, but may remain active to respond to user operation of applications displayed on the desktop interface. While users may activate the desktop application on any computer on the network, most users work from one specific computer.

Remote desktop virtualization solutions have been available for over a decade. These solutions provide virtual desktops to network users. Remote desktop traffic is typically open to internet traffic, therefore, security and authentication is typically enforced at multiple points in an IT infrastructure before a connection is established. This requires a certain amount of processing to determine if incoming requests from remote desktop users are legitimate.

There is a need for a Cloud based system that reduces resource consumption during authentication of remote desktop users. Thus, there is a need for a system that provides a simpler scheme for dealing with connection requests from unknown users and devices.

### SUMMARY

Some implementations of the present disclosure provide a virtual desktop system. The virtual desktop system includes one or more virtual desktops and associated public cloud infrastructure. The system further includes a control plane coupled to the public cloud infrastructure. In response to a client device application operated by a user requesting the one or more virtual desktops, the control plane is triggered to obtain information associated with the user and/or information associated with the client device application. The control plane is further triggered to provide the obtained information associated with the user and/or the information associated with the client device application to the public cloud infrastructure for storage.

Some implementations of the present disclosure provide a method for providing access to a virtual desktop to a user operating a client device. The method includes receiving a request from the client device requesting access to the one or more virtual desktops associated with a public cloud infrastructure. In response to receiving the request, the method further includes obtaining, by a control plane, information associated with the user and/or information associated with the client device. The method further includes providing the obtained information associated with the user and/or the information associated with the client device to the public cloud infrastructure. The method further includes storing the information associated with the client device at the public cloud infrastructure.

Some implementations of the present disclosure provide a non-transitory computer-readable medium having machine-readable instructions stored thereon, which when executed by a processor, cause the processor to: (a) receive a request from a client device requesting access to one or more virtual desktops associated with a public cloud infrastructure; (b) in response to receiving the request, obtain, by a control plane, information associated with a user operating the client device and/or information associated with the client device; (c) provide the obtained information associated with the user and/or the information associated with the client device to the public cloud infrastructure; (d) store the information associated with the client device at the public cloud infrastructure; (e) compare usernames and/or IP addresses to the stored information associated with the user and/or the stored information associated with the client device; and (f) permit the user access to the one or more virtual desktops in response to the comparison of the usernames and/or IP addresses matching the stored information.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1 is a high-level block diagram illustrating an example cloud desktop fabric allowing access to virtual desktops globally;

FIG. 2 is a block diagram of a cloud region and desktop service control plane of the example cloud desktop fabric in FIG. 1;

FIG. 3 illustrates a flow diagram for an authentication process for connecting a legitimate endpoint device to a public cloud infrastructure, according to some implementations of the present disclosure;

FIG. 4 illustrates a flow diagram for an authentication process during subsequent connections from known devices, according to some implementations of the present disclosure;

FIG. 5 illustrates a flow diagram for an authentication process when a connection fails from an unknown user and device;

FIG. 6 illustrates a flow diagram for initiating a connection, according to some implementations of the present disclosure.

FIG. 7 illustrates a flow diagram for handling suspicious remote desktop connections, according to some implementations of the present disclosure;

FIG. 8 illustrates a first exemplary system in accordance with various examples of the present disclosure; and

FIG. 9 illustrates a second exemplary system in accordance with various examples of the present disclosure.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present disclosure relates to a distributed network of desktop service capabilities that can be centrally administered and managed. The system is elastic, which allows the ability to provide desktop resources from multiple cloud regions that meet desktop requirements for a user in a dynamic way. The example system employs an authentication scheme to verify the identity of the user when the user attempts to use remote desktop resources. For example, the system can verify that the user is a legitimate user remotely connecting from an approved client device. The system can maintain a whitelist of approved users and/or client devices to expedite authenticating users. The system can also block or maintain a blacklist of suspicious users and/or devices to protect from unauthorized access.

The following are definitions of terms used in this disclosure that relate in general to the virtual desktop system.

An agent is software that performs certain operations and monitoring tasks that has direct access to, or runs on, some virtual computing resource and may maintain a duplex communication channel with a desktop service control plane.

An API is a set of specific, controlled, well-defined functional entry points to get, create, update, and delete resources and otherwise change the state of a remote system.

A cloud API is, in this context, an API specific to a cloud service provider.

A connection broker is desktop service resource sometimes used to dynamically connect desktop clients with desktops.

A cloud provider, also known as a cloud service provider, in this context, is an Infrastructure as a Service provider (IaaS) that provides virtual machines as a service in one or more cloud regions.

A cloud region is a collection of computing resources, such as virtual machine hosts, virtual networks, virtual storage devices, protocol gateways, servers, or other infrastructure in one physical location. The virtual resources are abstractions available to cloud customers, actually implemented by physical hardware such as networking equipment including but not limited to routers, hubs, switches, persistent storage devices such as disks, CPU and/or GPU processors, random access memory (RAM), security appliances including firewalls, operating system software, and other components that may be employed in a cloud regional data center to provide a hosting environment for virtual machines, sometimes known as a “server”, “host”, or “node.” A cloud region is typically described as being part of a public cloud, all the descriptions of the functionality apply equally to a private cloud whose availability is restricted to certain organizations.

A cloud availability zone is an isolated location within a cloud region, with some services that are redundant to other cloud availability zones within the same cloud region, in order to provide a higher level of availability in the event of an outage in a one location. A cloud service provider may allow resources such as virtual machines to be provisioned in a multiple specific availability zones, or may manage logical resources to be spread across availability zones automatically based on availability requirements, such as requiring that cloud resources are still available in the event of a power outage in one zone.

A virtual desktop is the information and capability needed to instantiate and manage, whenever needed, a specific virtual machine providing interactive desktop software or applications, or other experiences provided by remote desktop virtualization via a desktop service utilizing a cloud region.

A pool is a configuration object that describes a collection of virtual desktops, that is associated with a group of cloud desktop users, and certain attributes they have in common. For example, it may describe the common icon image used to launch a desktop.

A client, or desktop client (sometimes called a VDI client) is a software application that provides display and input access to a desktop as part of a desktop service. It may be installed on a standard desktop or mobile operating system, or be pre-installed on dedicated hardware devices, or downloaded dynamically via a web browser application, or deployed in some other way. Like an agent, it may also perform certain operations and monitoring tasks and may maintain a duplex communication channel with a desktop service control plane.

A cloud desktop fabric is a scalable virtual desktop interface system that orchestrates multiple regional fabric regions to allow a user anywhere to access a virtual desktop interface.

A desktop service resource refers to some virtualized hardware, networking service, or virtual machine, other than the desktops themselves, that exists to support a desktop service for use by cloud desktop users.

A desktop service is remote desktop virtualization hosted on a public or private cloud, provided as a turnkey managed service.

A desktop service control plane is an application that implements and manages a desktop service.

A cloud desktop user, also referred to as user, is a person who uses a cloud desktop.

An enterprise connector is a desktop service resource used to integrate the network of a desktop service with the network services, including but not limited to directory services that support authentication and authorization.

A gateway, sometimes referred to as a protocol gateway, is a type of desktop service resource running a service that manages secure access to a desktop supporting protocols including a remote display protocol (RDP). In this disclosure, gateways are accessed as a gateway cluster unless explicitly noted otherwise.

A gateway agent is an agent that operates on, and monitors a gateway.

A gateway cluster is a set of gateways managed together for load balancing purposes.

Infrastructure as a service (IaaS) is a set of virtualized computing resources available from a cloud service provider.

An infrastructure template is a collection of desktop service resources and/or definitions that provide a blueprint for replicating a cloud region's resources.

A multi-tenant desktop service control plane is a single desktop service control plane implementation that is used by multiple customers in such a way that no single customer is aware of or is impacted by activities of the others.

The term “near-real-time” refers to the processing timeframe of a system in which root cause information is produced without significant delay, close enough in time from the triggering events to be acted upon immediately to achieve business goals, typically measured as under one minute.

A non-persistent desktop user is a desktop user that is allocated a new desktop for each login session.

A persistent desktop user is a desktop user that is allocated a specific desktop for exclusive use over multiple connection sessions.

Pool desktops are a set of desktops managed by the desktop service control plane as a unit.

Remote desktop virtualization is software technology that separates the desktop environment and associated application software from the physical client device that is used to access it in a client/server environment.

A virtual application is the capability to access a user experience for a particular application running remotely.

A virtualized computing resource is a virtual machine that is created by an Infrastructure as a Service (IaaS) provider.

A virtual machine is an emulation of a physical computer that can be accessed over a network.

A virtual network is hardware and software network resources combined into a single, software-based administrative entity, made available by an Infrastructure as a Service (IaaS) provider.

Virtual storage is storage resources provided as part of Infrastructure as a Service.

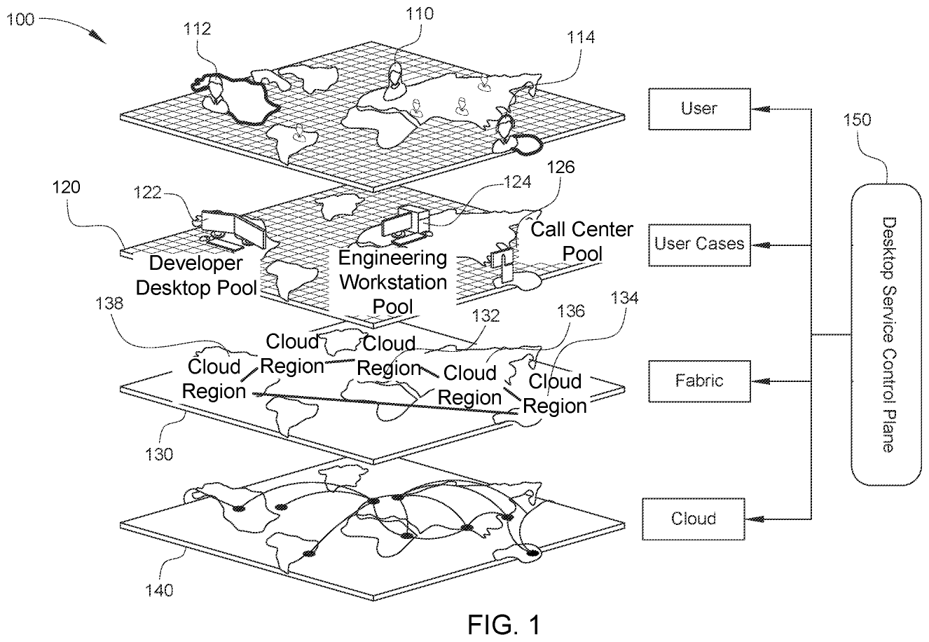

FIG. 1 shows a high level block diagram of a cloud desktop service system 100. The cloud desktop service system 100 may also be referenced as a global desktop system because it provides virtual desktops for users globally. The cloud desktop service system 100 includes four layers, a users layer 110, a use cases layer 120, a fabric layer 130, and a cloud layer 140.

The users layer 110 represents desktop users having the same computing needs, that may be located anywhere in the world. In this example, the users layer 110 includes users 112 and 114, who are in geographically remote locations and access desktops via computing devices.

The use cases layer 120 represents common pools of desktops available to serve the users, whereby each pool may be based on common desktop requirements. There can be multiple pools based on which groups users belong to and their job requirements. In this example, the pool for the users 112 and 114 may be one of a developer desktop pool 122, an engineering workstation pool 124, or a call center application pool 126. The desktops each include configuration and definitions of resources necessary to offer the desktop.

For example, pools such as the developer desktop pool 122 or the engineering workstation pool 124 allow users in the pool a desktop that allows access to graphic processing unit (GPU) based applications. Other example applications may include those applications used for the business of the enterprise, for example, ERP (enterprise resource planning) applications or CRM (customer relationship management) applications. These applications allow users to control the inventory of the business, sales, workflow, shipping, payment, product planning, cost analysis, interactions with customers, and so on. Applications associated with an enterprise may include productivity applications, for example, word processing applications, search applications, document viewers, and collaboration applications. Applications associated with an enterprise may also include applications that allow communication between people, for example, email, messaging, web meetings, and so on.

The fabric layer 130 includes definitions and configurations for infrastructure and desktop service resources, including gateways, desktop templates, and others that are applied to cloud regions. The resources are maintained as cloud regions such as cloud region 132, 134, 136, and 138. The cloud regions can be added or removed as needed.

The cloud layer 140 implements the resources defined by the use case layer 120 and fabric layer 130, including virtual desktops, infrastructure, and other virtual resources, all of which are virtual machines or other virtual resources hosted in a public or private cloud.

The layers 110, 120, 130, and 140 are created and orchestrated by a desktop service control plane 150 that can touch all the layers. The desktop service control plane 150 is a key component to orchestrate a cloud desktop service system such as the cloud desktop service system 100 in FIG. 1. The desktop service control plane 150 can manage the entire lifecycle of a desktop service implementation, from creating and managing the required desktops, to monitoring and analyzing the stream of operational data collected, enforcing security policies, and optimizing the experience for IT administrators and desktop users. For example, the desktop service control plane 150 may register a set of a virtual networks, virtual storage resources, and more. Within a virtual network, the control plane 150 may further register and coordinate the use of gateways, enterprise connectors, desktop templates, connection brokers, and more.

The two cloud desktop users 112 and 114 in different parts of the world who are each able to access an example high-performance desktop service from the cloud desktop service system 100. The cloud desktop service system 100 eliminates the need to divide cloud users with similar requirements into user groups specific to a region. In some implementations, all users having similar needs throughout the world are considered as a single worker pool. Cloud desktop users, such as cloud desktop users 112 and 114, each may use a client device to access the desktop service. Client devices may be any device having computing and network functionality, such as a laptop computer, desktop computer, smartphone, or tablet. Client devices execute a desktop client to access remote applications such as the desktop. The client application authenticates user access to the applications. A client device can be a conventional computer system executing, for example, a Microsoft™ Windows™-compatible operating system (OS), Apple™ OS X, and/or a Linux distribution. A client device can also be a client device having computer functionality, such as a personal digital assistant (PDA), mobile telephone, tablet, video game system, etc. In this example, the client application displays an icon of the desktop or desktops available to the user. As will be explained, the desktop is made available to the user through the client application on the user device.

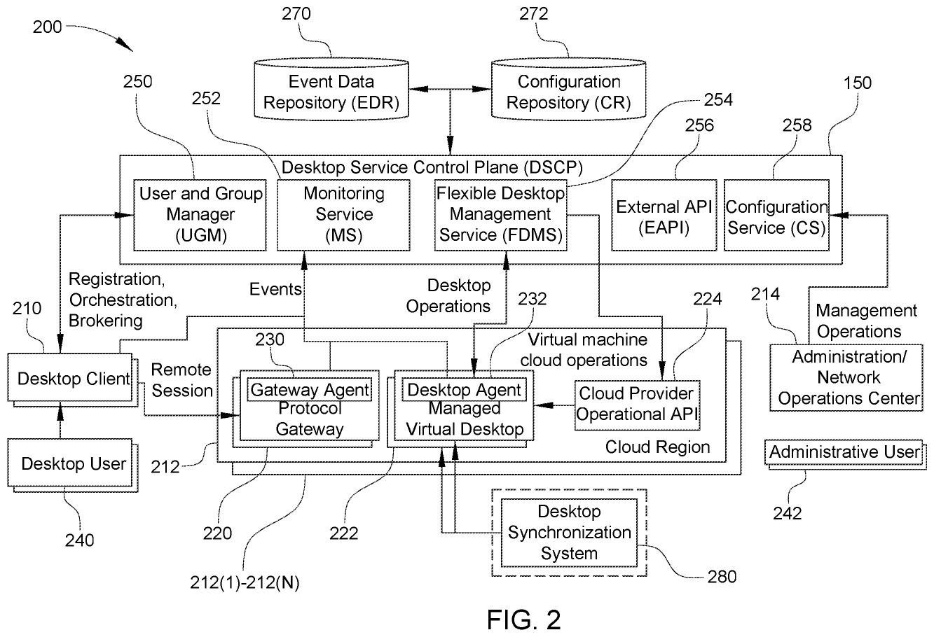

FIG. 2 is a block diagram of some examples of components of the cloud desktop service system 100, including an example set of desktop clients 210, a cloud region 212, and an administration center 214, that interact with and can be orchestrated by the desktop service control plane 150. The desktop client 210 communicates with the desktop service control plane 150 in order to be registered with the fabric, assigned a desktop, remotely configured, and for other purposes. There may be multiple cloud regions (e.g., cloud regions 212(1) to 212(N)) similar to the cloud region 212, but only one cloud region 212 is shown in detail for simplicity of explanation. The cloud region 212 may include a set of protocol gateways 220, a set of managed cloud desktops 222, and a cloud service provider operational API 224. These components all communicate with the desktop service control plane 150. The cloud region 212 may support one of the fabric regions 132, 134, 136, and 138 in FIG. 1.

Such cloud regions include servers that host the various applications as well as appropriate storage capabilities, such as virtual disks, memory, and network devices. Thus, the cloud region 212 typically comprises IT infrastructure that is managed by IT personnel. The IT infrastructure may include servers, network infrastructure, memory devices, software including operating systems, and so on. If there is an issue related to an application reported by a user, the IT personnel can check the health of the infrastructure used by the application. A cloud region may include a firewall to control access to the applications hosted by the cloud region. The firewall enables computing devices behind the firewall to access the applications hosted by the cloud region, but prevents computing devices outside the firewall from directly accessing the applications. The firewall may allow devices outside the firewall to access the applications within the firewall using a virtual private network (VPN).

The protocol gateway 220 may be present to provide secure public or internal limited access to the managed virtual desktops, that may be deployed on a virtual machine of its own. A gateway agent 230 is software that is deployed on that gateway virtual machine by the desktop service control plane 150, and serves to monitor the activity on the gateway 220, and enable the desktop service control plane 150 to assist in configuration and operations management of the gateway 220.

The example desktop client 210 is software and device hardware available in the local environment of a desktop user 240 to remotely access a managed virtual desktop using a remote desktop protocol. The desktop client 210 communicates with the desktop service control plane 150 and also supports a remote display protocol in order for users to connect to a desktop application run by the cloud region 212.

The managed virtual desktop 222 is itself provisioned and maintained by the desktop service control plane 150. A desktop template may be used to manage pools of such managed virtual desktops. The desktop template is configured to provide remote access to the desktop client 210. A desktop agent such as desktop agent 232 is software that is deployed on that managed virtual desktop by the desktop service control plane 150, and serves to monitor the activity on the managed virtual desktop, and enable the desktop service control plane 150 to assist in configuration and operations management of the managed virtual desktop.

The cloud service provider operational application programming interface (API) 224 presents services provided by the cloud service provider that also participate in the management of the virtual machine. This can be utilized by a desktop service control plane 150 to perform operations like provisioning or de-provisioning the virtual machine.

Administrative users 242 can interact with operations reporting interface software at the administration center 214 that allows management and administration of the desktop service control plane 150.

Other components and services may interact with the desktop service control plane but are omitted from FIG. 2 for simplicity, such as enterprise connectors, network monitoring services, customer relationship management (CRM) systems, and many others.

The desktop service control plane 150 itself can perform many internal centralized functions also not depicted in in FIG. 2, including pool management, user and group management, cloud service adapters, virtual desktop templates, data analysis, high-availability management, mapping users to the optimal cloud region, security policy management, monitoring, compliance, reporting, and others.

The control plane 150 includes a user and group manager 250, a monitoring service 252, a flexible desktop management service (DMS) 254, an external API (EAPI) 256, and a configuration service (CS) 258. The control plane 150 may access an event data repository 270 and a configuration repository 272. Although only one cloud region 212 is shown in detail, it is to be understood that the control plane 150 may facilitate numerous cloud regions.

The monitoring service 252 makes both routine and error events available to administrators and can analyze operational performance and reliability. The monitoring service 252 interacts with components including the desktop client 210, gateway agent 230, desktop agent 232, and those generated by the control plane 150 itself. The flexible desktop management service 254 interacts with the one or more managed virtual machines (MVMs) 222 in the cloud region 212 and other regional cloud regions 212(1) to 212(N). In some implementations, the flexible desktop management service 254 manages resources for providing virtual desktops to the users in the pools, orchestrating the lifecycle of a logical desktop. In some implementations, multiple virtual desktops for the same logical desktop may be created by the flexible desktop management system 254 to ensure the virtual desktop accessed by a user operates optimally by changing the selection of the virtual desktop in response to changes in conditions.

The administration center 214 works directly with the data control plane 150 as its primary human interface. The administration center 214 allows the administrative user 242 to configure the functions of the control plane 150 through the configuration service 258. The configuration service 258 supports editing and persistence of definitions about the desktop service, including subscription information and policies. The administration center 214 may be where the desktop requirement dimensions are configured by the administrative user 242.

The system 200 in FIG. 2 allows a user to access a remote virtual desktop (or cloud desktop). Typically, the user should be authorized to use the cloud desktop service system 100. The control plane 150 allows legitimate users to launch a cloud desktop by connecting to the remote virtual desktop from an endpoint device (e.g., the desktop client 210). The remote virtual desktop is typically connected to through a remote desktop protocol gateway (e.g., the protocol gateway 220) that is open to any internet traffic. Authentication of users typically is enforced on both the remote desktop protocol gateway and by the cloud desktop as well. By requiring authentication on both the remote desktop protocol gateway and the cloud desktop, a processing overhead is required to determine if an incoming request from the desktop client 210 is from a legitimate user. That is, whether the desktop client 210 providing the incoming request is being directed by the desktop user 240 that is authorized to access the cloud desktop service system 100.

Some implementations of the present disclosure provide that the control plane 150 works with dedicated client software deployed on the desktop client 210 and the gateway agent 230. In some implementations, the desktop client 210 is a legitimate endpoint device (i.e., a device approved to connect to the cloud desktop service system 100). The desktop client 210 authenticates with the control plane 150. The control plane 150 is configured to maintain user(s) (e.g., the desktop user 240) and/or device(s) information (e.g., the desktop client 210). In an example, maintaining user and/or device information includes associating and storing username(s) and source IP address(es). In some implementations, the username(s) and source IP address(es) are stored for only legitimate users. In some implementations, the username(s) and source IP address(es) are stored for both legitimate and unauthorized users. In some implementations, the username(s) and source IP address(es) are stored temporarily for some specified period of time. The period of time can be for 30 minutes, for 1 hour, for 1 day, for 1 week, etc.

The control plane 150 makes the user(s) and/or device(s) information available to the gateway agent 230, which in turn can configure the gateway protocol service to accept connection requests from legitimate users on legitimate devices identified in the user(s) and/or device(s) information. In some implementations, other users from other devices will not be able to connect. That is, in a pairwise association of (user, device information), if the user and device information do not match, then the user is not allowed to connect. Some implementations of the present disclosure reduce resource consumption caused by connection requests from unknown users and devices. For example, unknown IP addresses can be refused connection if a known user is trying to connect from the unknown IP address.

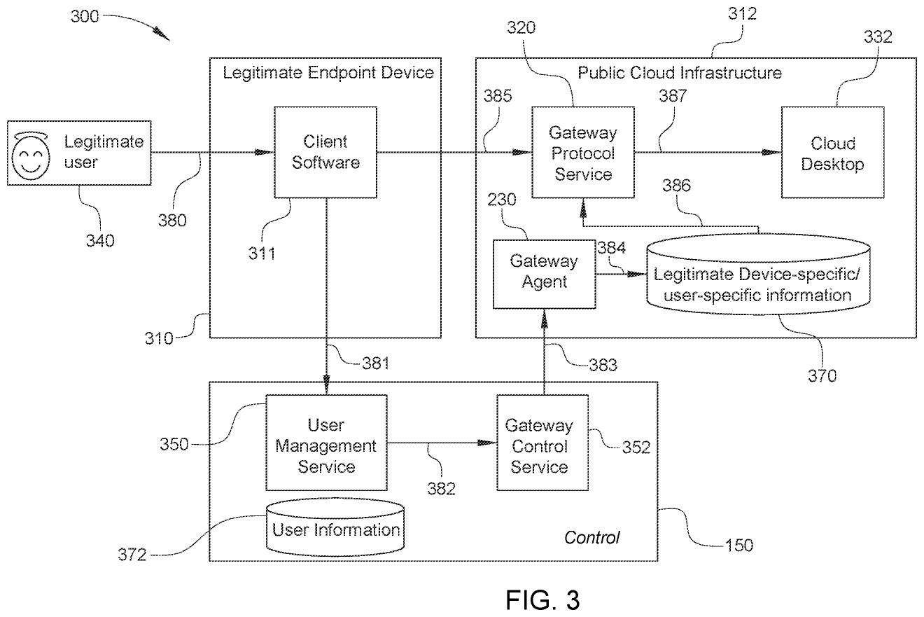

Some implementations of the present disclosure provide IP whitelisting and IP blacklisting. IP whitelisting involves granting network access to only specified IP addresses, while IP blacklisting involves denying network access to the specified IP addresses. FIG. 3 shows a flow diagram for an authentication process for connecting a legitimate endpoint device 310 to a public cloud infrastructure 312, according to some implementations of the present disclosure. FIG. 3 shows a system 300 which is similar to or the same as the system 200. The system 300 is simplified to facilitate discussion of the different aspects of the authentication process. The legitimate endpoint device 310 is similar to or the same as the desktop client 210 (FIG. 2). The legitimate endpoint device 310 runs a client software 311. The public cloud infrastructure 312 is similar to or the same as the cloud region 212 (FIG. 2). The control plane 150 in FIG. 3 is simplified to include a user management service 350, a gateway control service 352, and a user information data store 372.

The user management service 350 can perform tasks associated with the user and group manager 250, and/or the configuration service 258. The gateway control service 352 can perform tasks associated with the monitoring service 252, and/or the flexible desktop management service 254.

The public cloud infrastructure 312 includes a gateway protocol service 320, a cloud desktop 332, the gateway agent 230, and a data store 370 for legitimate device-specific and/or user-specific information. The gateway protocol service 320 is similar to the protocol gateway 220 (FIG. 2). The cloud desktop 332 is similar to the managed virtual desktop 232 (FIG. 2). Eight steps 380 through 387 are highlighted in the authentication process of FIG. 3.

At step 380, the legitimate user 340 attempts to launch a connection to the system 300 using the client software 311 on the legitimate endpoint device 310.

At step 381, the client software 311 interacts with the control plane 150. The control plane 150 validates the user 340 and captures additional information about the user 340. In some implementations, the control plane 150 captures an IP address associated with the legitimate endpoint device 310. In some implementations, the control plane 150 requires a registration of the legitimate endpoint device 310 before attempting a first authentication. That is, the authentication process would occur after the legitimate endpoint device 310 is already registered and its information is known by the control plane 150. In some implementations, the client software 311 may omit step 381 if the IP address information was previously passed to the control plane 150 within a configurable time period.

The IP address is used merely as an example. In some implementations, the control plane 150 captures identifying device information exposed by the client software 311. For example, device details can be added as additional payload within the connection protocol. Device details can include a media access control (MAC) address of the legitimate endpoint device 310. In some implementations, more than one device detail is used for verification purposes. For example, the IP address along with the MAC address is captured by the control plane 150.

Optionally, at step 382, the control plane 150 includes a distinct gateway control service (i.e., the gateway control service 352) running within the control plane 150 that manages communication with the gateway agent 230. If a distinct gateway control service is not provided in the control plane 150, one or more of the services illustrated in FIG. 2 can perform tasks attributed to the gateway control service 352.

At step 383, the control plane 150 passes the information about the user 340 and the information about the legitimate endpoint device 310 to the gateway agent 230 using a secure communication method. In an example, the secure communication method involves a push of the information over a web socket connection that is maintained between the control plane 150 and the gateway agent 230. As indicated in FIG. 2, multiple cloud regions 212(1)-212(N) can be provided, thus in some implementations multiple public cloud infrastructures 312 each having its respective agent 230 is provided. The control plane 150 can provide the information using the secure communication method to each of the gateway agents 230 of the multiple public cloud infrastructures 312. In some implementations, the multiple gateway agents 230 represent a cluster of gateways, so that any gateway configured for use by the user 340 will receive the information.

At step 384, the gateway agent 230 is responsible for managing aspects of the gateway protocol service 320. The gateway agent 230 updates a list of valid users and device information, such as valid IP addresses, that may be used to validate a connection to the cloud desktop 332. The gateway agent 230 stores this information in the data store 370 for future use.

At step 385, once the user and device information is known to the gateway protocol service 320, the client software 311 proceeds to attempt to connect to the gateway protocol service 320 to initiate a remote desktop session. The client software 311 can use multiple ways to determine when to attempt the connection for initiating the remote desktop session. For example, the client software 311 can retry the connection attempt repeatedly, after a programmed delay, or periodically. In some implementations, the client software 311 retries the connection after a programmed delay between 5 seconds and one minute (e.g., 5 seconds, 10 seconds, 20 seconds, 30 seconds, 45 seconds, etc.).

In some implementations, instead of having repeated connection attempts that may fail, a signal can be relayed back to the client software 311 after the gateway agent 230 stores the information at step 384. In an example, the gateway agent 230 can provide a ready signal to the client software 311. The ready signal can be used as an indication that the public cloud infrastructure 312 is ready for the client software 311 to attempt a connection.

In some implementations, an end user interaction is supported by the client software 311 specifically for the case where the user 340 information and legitimate endpoint device 310 information is new. For example, the user 340 (via the client software 311) can be asked to be patient while the user 340 information and the legitimate endpoint device 310 information is propagated to the gateway agent 230. In some implementations, a more complex interaction can occur, such as, requiring additional validation factors.

At step 386, the gateway protocol service 320 receives the connection request, that includes user and device information from the client software 311 and references this received information against the user and device information stored in the data store 370.

At step 387, if the user 340 is considered legitimate the connection with the cloud desktop 332 is completed.

In some embodiments, the gateway agent 230 can also remove valid user and device information after some period of time has elapsed, so that allowing connections from that user and device context is time-limited. For example, a user j doe attempts to connect from the Wi-Fi network of a coffee shop while travelling. The user and device information specific to that context (i.e., the IP address of the coffee shop's network) is only retained for one day, based on a configuration policy. The configuration policy may or may not include specific rules about the originating IP address.

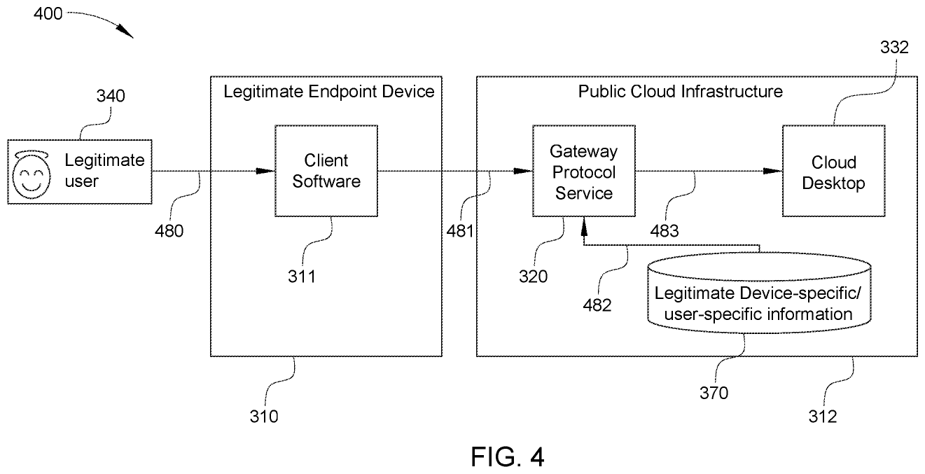

FIG. 3 illustrated a process for first time authentication, but once the user and the device are known to the system 200, then a more efficient flow can be established based on FIG. 4. FIG. 4 illustrates a flow diagram for an authentication process during subsequent connections from a known device (i.e., the legitimate endpoint device 310), according to some implementations of the present disclosure. The system 400, when dealing with known devices, does not need to interact with the control plane 150 (FIG. 3), as such, the system 400 deals with only a sub sect of the components of the system 300.

As discussed in connection with FIG. 3, in some implementations, the user and device information may be considered valid only for some configurable time window, after which, the user and device information is invalided or discarded. Managing the user and device information in this manner may help reduce overhead from repeated requests from the same user and device and can enhance security. For example, once a user j doe connects from a coffee shop's public Wi-Fi network, the system 400 can be configured to continue to allow access from that network for some period of time with a streamlined interaction. Therefore, FIG. 4 provides an example flow diagram illustrating the steps 480 to 483 taken, when the user and device are already known to the gateway protocol service 320.

At step 480, the legitimate user 340 attempts to launch the connection using the client software 311.

At step 481, the client software 311 immediately proceeds to attempt to connect to initiate a remote desktop session. In contrast to the embodiment of FIG. 3, the client 311 does not interact with the control plane 150, since the user and device information is already propagated to the gateway protocol service 320 and stored in the data store 370 when an earlier connection was recently made.

At step 482, the gateway protocol service 320 receives the connection request, that includes user and device information from the client software 311, and references this against the user and device information in the data store 370.

At step 483, if the user is considered legitimate, the connection with the cloud desktop 332 is completed.

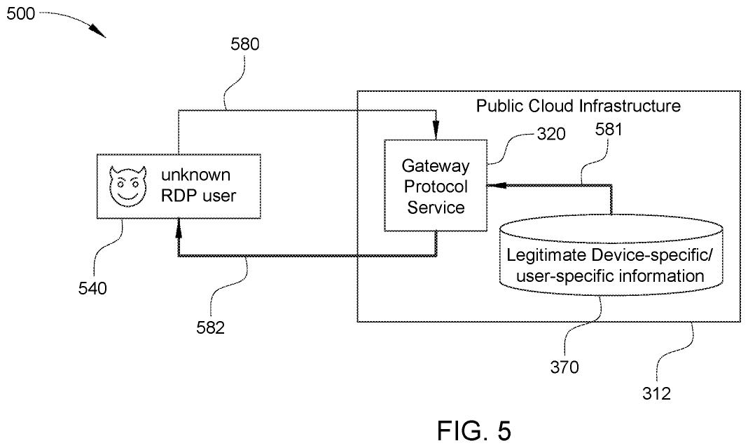

FIG. 4 illustrated a flow for subsequent connections from a known device. In some implementations, when a connection is attempted by some other device or user that is not known, then the process in FIG. 5 is followed. FIG. 5 illustrates a flow diagram for an authentication process when a connection fails from an unknown user and/or device, according to some implementations of the present disclosure. If a connection is attempted by some other device or user, and the user and device information is not found in the gateway protocol service 320, then the request is rejected. Steps 580-582 are performed when rejecting the request.

At step 580, an unknown user 540 (and/or an unknown device) attempts a connection request.

At step 581, the gateway protocol service 320 does not find the combination of the user 540 and the device. In some implementations, the combination of the user 540 and the device has expired. The data store 370 includes legitimate device-specific/user-specific information and information in the data store 370 can be compared against the user 540 and the client device that the user 540 is trying to connect from.

At step 582, a connection failure is returned to the originating device.

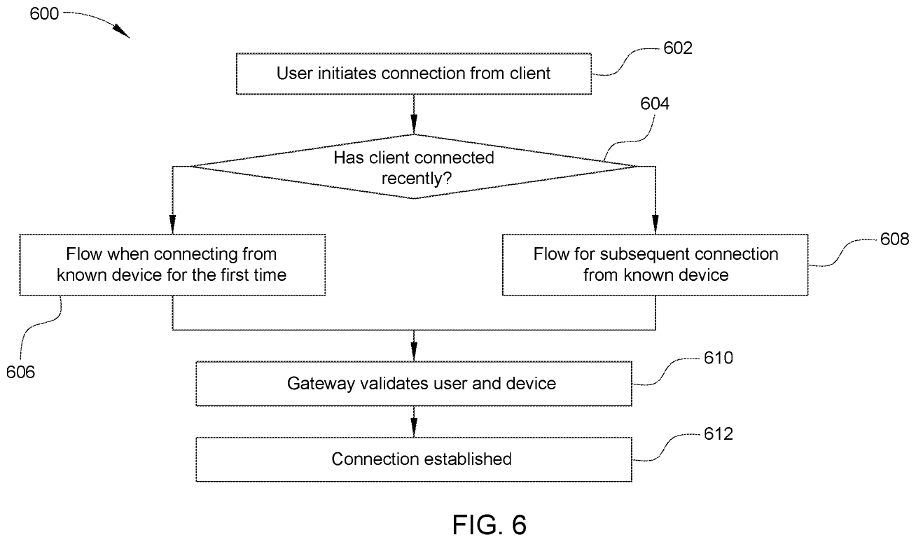

FIG. 3 describes making an initial connection to access a cloud desktop 332, FIG. 4 describes authenticating a known device after the initial connection, and FIG. 5 describes an example result when the connection request is rejected by the public cloud infrastructure 312. In some implementations, after the connection request is rejected, the client software (e.g., the client software 311) can recover from a rejected connection request by initiating the process flow of FIG. 3 to try connecting using a specific user and device information for the first time. FIG. 6 provides a summary of this process of initiating a connection, according to some implementations of the present disclosure.

At step 602, the user initiates a connection from the client software.

At step 604, the gateway protocol service 320 determines whether the client software has recently connected. In some implementations, a client that has recently connected is logged in the data store 370, and a comparison is made to determine whether the user initiating the connection in step 602 is present in the data store 370.

At step 606, if the client software had not previously connected, then the authentication process of FIG. 3 is followed.

At step 608, if the client software had previously connected, then the authentication process of FIG. 4 is followed.

At step 610, the gateway protocol service 320 validates the user and device. At step 612, a connection is established to one or more cloud desktops (e.g., the cloud desktop 332 of FIG. 4).

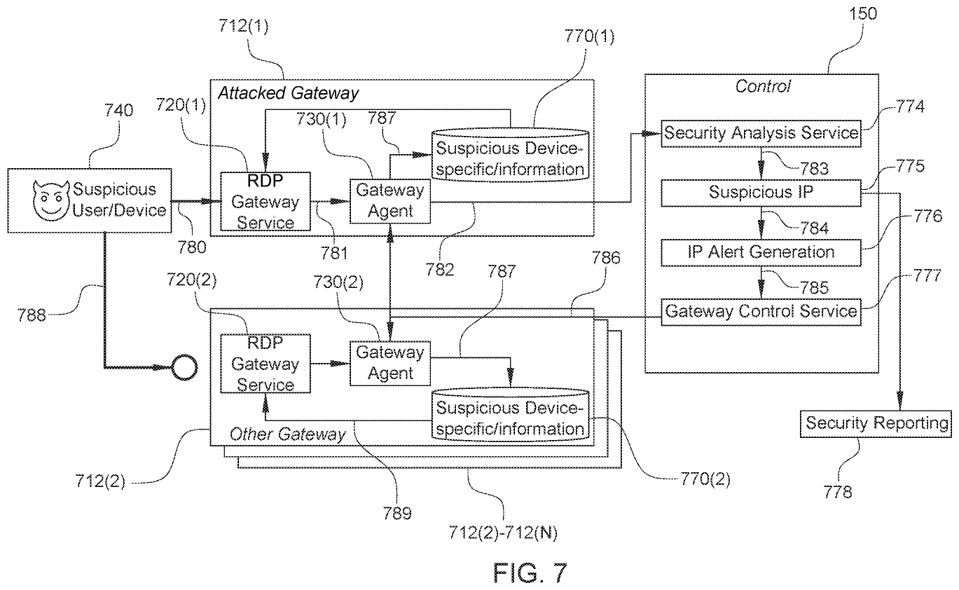

FIGS. 3-6 provided examples of IP whitelisting. Some embodiments of the present disclosure provide a system for IP blacklisting. FIG. 7 illustrates a flow diagram for handling suspicious remote desktop connections, according to some implementations of the present disclosure. The system of FIG. 7 includes a suspicious user and/or device 740 attempting to connect to a first gateway 712(1). The first gateway 712(1) is one of a plurality of gateways 712(1)-712(N). The gateways 712(1)-712(N) are the same as the public cloud infrastructure of FIG. 3 and/or the cloud region(s) 212(1)-212(N) of FIG. 2. Gateway agents (e.g., a gateway agent 730(1)) can not only maintain a list of legitimate user and device information, but can also collect a list of rejected IP addresses for forwarding to the control plane 150. The gateway agents are similar to or the same as the gateway agent 230 (FIG. 2). The suspicious user and/or device 740 initiates the gateway agent 730(1) collecting device information (e.g., IP information) via the remote desktop protocol (RDP) gateway service 720(1).

The control plane 150 includes a security analysis service 774 that curates a blacklist of IP addresses received at the control plane 150. Additionally, the blacklist of IP addresses can be forwarded to a much broader set of gateways (e.g., one or more of the other gateways 712(2)-712(N)), possibly including gateways utilized for other applications or other customers of the cloud desktop service 100 (FIG. 1). In some implementations, when the cloud region 212(1) (FIG. 2) is attacked, the blacklist of IP addresses can be sent to a specific set of cloud regions (e.g., the cloud regions 212(2) and 212(4) of FIG. 2) or can be sent to all cloud regions (e.g., the cloud regions 212(2)-212(N)). In some implementations, the specific set of cloud regions that receive the blacklist of IP addresses is based on the applications available at those cloud regions. In some implementations, the blacklist of IP addresses applies only to specific pool desktops (e.g., the developer desktop pool 122 of FIG. 1). As described herein, blocking of certain IP addresses can be more granular than at the cloud regions level (i.e., blocking can occur at the applications level and/or at the group of customers or users level). Alternatively, blocking of certain IP addresses can be less granular (e.g., global blocking of malicious IP addresses can occur across all cloud regions, across all cloud providers, and/or across all customers).

In some implementations, security appliances such as firewalls or other third party security services can be used to perform actual IP blocking once an IP has been blacklisted. In some implementations, other captured device information like a MAC address can be used as a secondary point of comparison for blocking the suspicious user/device 740. Steps 780 to 789 perform a process of identifying and globally blocking suspicious RDP protocol IP, according to some implementations of the present disclosure.

At step 780, user and device information provided by the suspicious user/device 740 is used to attempt a connection to the attacked gateway 712(1). Information associated with the suspicious user/device 740 is not found in the list of legitimate user and device information. The suspicious user/device 740 is rejected by the RDP gateway service 720(1) in a similar manner as described herein in connection with FIG. 5.

At step 781, the rejected information is picked up by the gateway agent 730(1). The rejected information can include an IP address, a MAC address, software versions of client software used to attempt the remote desktop connection, etc.

At step 782, the gateway agent 730(1) forwards the rejected information to the security analysis service 774.

At step 783, the security analysis service 774 stores this information (i.e., the suspicious IP 775) for some time period. The security analysis service 774 also makes the suspicious IP 775 available for reporting purposes to give visibility to current or potential attacks. Under security reporting 778, security events can be aggregated/summarized, security events can be triaged, and/or notification of security events can be provided to administrators.

At step 784, an IP alert generation service 777 determines which gateways to propagate the suspicious IP 775 to. In some implementations, the IP alert generation service 777 determines to forward the suspicious IP 775 to every gateway it operates, anywhere in the world.

At step 785, the gateway control service 777 (similar to or the same as the gateway control service 352 of FIG. 3) has access to the output of the IP alert generation service 777.

At step 786, the gateway control service 777 has a secure communication path with every agent and can propagate the information to a multiplicity of agents, including the originally attacked gateway.

At step 787, the gateway agent (e.g., the gateway agent 730(2)) updates its copy of the blacklist in the datastore 770(2).

Optionally, at step 788, the RDP gateway service 720(2) may receive another attempt from the same suspicious user and device 740 information.

At step 789, the RDP gateway service 720(2) checks the information against the blacklist stored in the data store 770(2). The attempt is rejected. In some implementations, while not depicted in FIG. 7, this intrusion attempt may also be reported by the gateway agent 730(2) to the security analysis service 774 in the control plane 150.

Embodiments of the present disclosure provide enhanced protection of a customer's public cloud infrastructure, such as remote desktop protocol gateways. Embodiments of the present disclosure provide enhanced protection of a customer's public cloud desktop virtual machines. Embodiments of the disclosure provide reduced risk of successful exploitation of vulnerabilities allowing attacks on customer network infrastructure or any other resources joined to the customer network. Embodiments of the disclosure provide visibility of attempted attacks or other anomalies attributed to malicious actors that would otherwise be undetected. The desktop service control plane, client software, and agent software components create orchestration such that only valid users from known devices (e.g., IP address) are accepted by a gateway. Conventionally, each connection request must trigger a full authentication activity, which can be resource intensive and can cause additional exposures to network intrusion. The likelihood of an unknown RDP user gaining access is higher in conventional means when compared to various embodiments of the present disclosure.

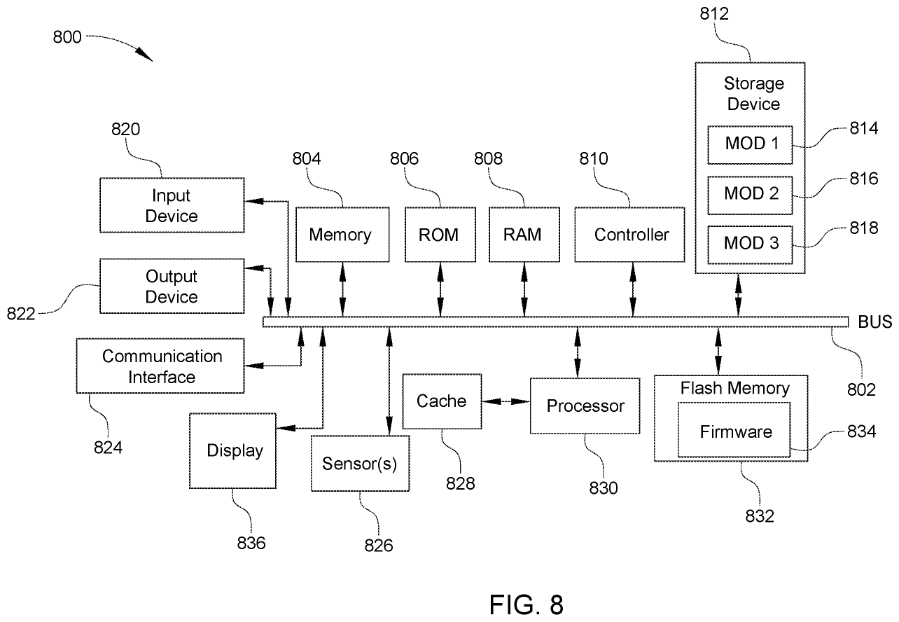

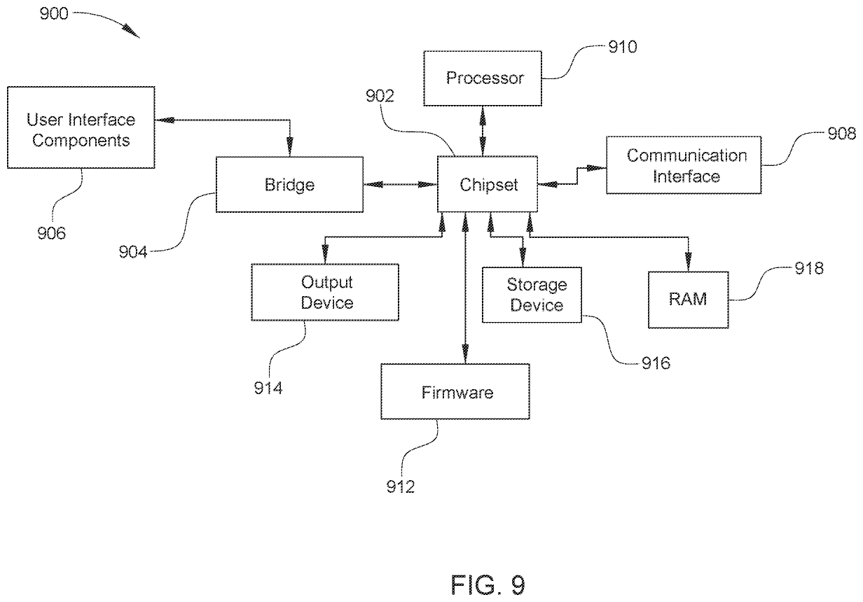

FIGS. 8-9 illustrate an example computing system 800, in which the components of the computing system are in electrical communication with each other using a bus 802. The system 800 includes a processing unit (CPU or processor) 830 and a system bus 802 that couple various system components, including the system memory 804 (e.g., read only memory (ROM) 806 and random access memory (RAM) 808), to the processor 830. The system 800 can include a cache of high-speed memory connected directly with, in close proximity to, or integrated as part of the processor 830. The system 800 can copy data from the memory 804 and/or the storage device 812 to the cache 828 for quick access by the processor 830. In this way, the cache can provide a performance boost for processor 830 while waiting for data. These and other modules can control or be configured to control the processor 830 to perform various actions. Other system memory 804 may be available for use as well. The memory 804 can include multiple different types of memory with different performance characteristics. The processor 830 can include any general purpose processor and a hardware module or software module, such as module 1 814, module 2 816, and module 3 818 embedded in storage device 812. The hardware module or software module is configured to control the processor 830, as well as a special-purpose processor where software instructions are incorporated into the actual processor design. The processor 830 may essentially be a completely self-contained computing system that contains multiple cores or processors, a bus, memory controller, cache, etc. A multi-core processor may be symmetric or asymmetric.

To enable user interaction with the computing device 800, an input device 820 is provided as an input mechanism. The input device 820 can comprise a microphone for speech, a touch-sensitive screen for gesture or graphical input, keyboard, mouse, motion input, and so forth. In some instances, multimodal systems can enable a user to provide multiple types of input to communicate with the system 800. In this example, an output device 822 is also provided. The communications interface 824 can govern and manage the user input and system output.

Storage device 812 can be a non-volatile memory to store data that is accessible by a computer. The storage device 812 can be magnetic cassettes, flash memory cards, solid state memory devices, digital versatile disks, cartridges, random access memories (RAMs) 808, read only memory (ROM) 806, and hybrids thereof.

The controller 810 can be a specialized microcontroller or processor on the system 800, such as a BMC (baseboard management controller). In some cases, the controller 810 can be part of an Intelligent Platform Management Interface (IPMI). Moreover, in some cases, the controller 810 can be embedded on a motherboard or main circuit board of the system 800. The controller 810 can manage the interface between system management software and platform hardware. The controller 810 can also communicate with various system devices and components (internal and/or external), such as controllers or peripheral components, as further described below.

The controller 810 can generate specific responses to notifications, alerts, and/or events, and communicate with remote devices or components (e.g., electronic mail message, network message, etc.) to generate an instruction or command for automatic hardware recovery procedures, etc. An administrator can also remotely communicate with the controller 810 to initiate or conduct specific hardware recovery procedures or operations, as further described below.

The controller 810 can also include a system event log controller and/or storage for managing and maintaining events, alerts, and notifications received by the controller 810. For example, the controller 810 or a system event log controller can receive alerts or notifications from one or more devices and components, and maintain the alerts or notifications in a system event log storage component.

Flash memory 832 can be an electronic non-volatile computer storage medium or chip that can be used by the system 800 for storage and/or data transfer. The flash memory 832 can be electrically erased and/or reprogrammed. Flash memory 832 can include EPROM (erasable programmable read-only memory), EEPROM (electrically erasable programmable read-only memory), ROM, NVRAM, or CMOS (complementary metal-oxide semiconductor), for example. The flash memory 832 can store the firmware 834 executed by the system 800 when the system 600 is first powered on, along with a set of configurations specified for the firmware 834. The flash memory 832 can also store configurations used by the firmware 834.

The firmware 834 can include a Basic Input/Output System or equivalents, such as an EFI (Extensible Firmware Interface) or UEFI (Unified Extensible Firmware Interface). The firmware 834 can be loaded and executed as a sequence program each time the system 800 is started. The firmware 834 can recognize, initialize, and test hardware present in the system 600 based on the set of configurations. The firmware 834 can perform a self-test, such as a POST (Power-On-Self-Test), on the system 800. This self-test can test the functionality of various hardware components such as hard disk drives, optical reading devices, cooling devices, memory modules, expansion cards, and the like. The firmware 834 can address and allocate an area in the memory 804, ROM 806, RAM 808, and/or storage device 812, to store an operating system (OS). The firmware 834 can load a boot loader and/or OS, and give control of the system 800 to the OS.

The firmware 834 of the system 800 can include a firmware configuration that defines how the firmware 834 controls various hardware components in the system 800. The firmware configuration can determine the order in which the various hardware components in the system 800 are started. The firmware 834 can provide an interface, such as an UEFI, that allows a variety of different parameters to be set, which can be different from parameters in a firmware default configuration. For example, a user (e.g., an administrator) can use the firmware 834 to specify clock and bus speeds, define what peripherals are attached to the system 800, set monitoring of health (e.g., fan speeds and CPU temperature limits), and/or provide a variety of other parameters that affect overall performance and power usage of the system 800. While firmware 834 is illustrated as being stored in the flash memory 832, one of ordinary skill in the art will readily recognize that the firmware 834 can be stored in other memory components, such as memory 804 or ROM 806.

System 800 can include one or more sensors 826. The one or more sensors 826 can include, for example, one or more temperature sensors, thermal sensors, oxygen sensors, chemical sensors, noise sensors, heat sensors, current sensors, voltage detectors, air flow sensors, flow sensors, infrared thermometers, heat flux sensors, thermometers, pyrometers, etc. The one or more sensors 826 can communicate with the processor, cache 828, flash memory 832, communications interface 824, memory 804, ROM 806, RAM 808, controller 810, and storage device 812, via the bus 802, for example. The one or more sensors 826 can also communicate with other components in the system via one or more different means, such as inter-integrated circuit (I2C), general purpose output (GPO), and the like. Different types of sensors (e.g., sensors 826) on the system 800 can also report to the controller 810 on parameters, such as cooling fan speeds, power status, operating system (OS) status, hardware status, and so forth. A display 836 may be used by the system 800 to provide graphics related to the applications that are executed by the controller 810.

FIG. 9 illustrates an example computer system 900 having a chipset architecture that can be used in executing the described method(s) or operations, and generating and displaying a graphical user interface (GUI). Computer system 900 can include computer hardware, software, and firmware that can be used to implement the disclosed technology. System 900 can include a processor 910, representative of a variety of physically and/or logically distinct resources capable of executing software, firmware, and hardware configured to perform identified computations. Processor 910 can communicate with a chipset 902 that can control input to and output from processor 910. In this example, chipset 902 outputs information to output device 914, such as a display, and can read and write information to storage device 916. The storage device 916 can include magnetic media, and solid state media, for example. Chipset 902 can also read data from and write data to RAM 918. A bridge 904 for interfacing with a variety of user interface components 906, can be provided for interfacing with chipset 902. User interface components 906 can include a keyboard, a microphone, touch detection, and processing circuitry, and a pointing device, such as a mouse.

Chipset 902 can also interface with one or more communication interfaces 908 that can have different physical interfaces. Such communication interfaces can include interfaces for wired and wireless local area networks, for broadband wireless networks, and for personal area networks. Further, the machine can receive inputs from a user via user interface components 906, and execute appropriate functions, such as browsing functions by interpreting these inputs using processor 910.

Moreover, chipset 902 can also communicate with firmware 912, which can be executed by the computer system 900 when powering on. The firmware 912 can recognize, initialize, and test hardware present in the computer system 900 based on a set of firmware configurations. The firmware 912 can perform a self-test, such as a POST, on the system 900. The self-test can test the functionality of the various hardware components 902-918. The firmware 912 can address and allocate an area in the memory 918 to store an OS. The firmware 912 can load a boot loader and/or OS, and give control of the system 900 to the OS. In some cases, the firmware 912 can communicate with the hardware components 902-910 and 914-918. Here, the firmware 912 can communicate with the hardware components 902-910 and 914-918 through the chipset 902, and/or through one or more other components. In some cases, the firmware 912 can communicate directly with the hardware components 902-910 and 914-918.

It can be appreciated that example systems 800 (in FIG. 8) and 900 can have more than one processor (e.g., 830, 910), or be part of a group or cluster of computing devices networked together to provide greater processing capability.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware, generalized hardware made specialized by the execution of software thereon that enables the hardware to perform specific function, software stored on a computer-readable medium, or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A virtual desktop system comprising:
one or more virtual desktops and associated public cloud infrastructure; and
a control plane coupled to the public cloud infrastructure, wherein in response to a client device application operated by a user requesting the one or more virtual desktops, the control plane is triggered to
obtain information associated with the user and/or information associated with the client device application, and
provide the obtained information associated with the user and/or the information associated with the client device application to the public cloud infrastructure for storage;
wherein the public cloud infrastructure is configured to
compare usernames and/or device information including IP addresses to the stored information associated with the user and/or the stored information associated with the client device, and
permit the user access to the one or more virtual desktops in response to the comparison of the usernames and/or IP addresses matching the stored information.

2. The system of claim 1, wherein both the usernames and IP addresses must match with the stored information.

3. The system of claim 1, wherein the public cloud infrastructure is configured to restrict the user access to the one or more virtual desktops in response to the comparison of the usernames and/or the IP addresses not matching the stored information.

4. The system of claim 3, wherein the public cloud infrastructure is configured to provide, to the control plane for security analysis, the usernames and/or the IP addresses not matching the stored information.

5. The system of claim 4, wherein the control plane is configured to provide at least one other public cloud infrastructure with the usernames and/or IP addresses not matching the stored information for a blacklist storage.

6. The system of claim 5, wherein the usernames and/or IP addresses not matching the stored information are used to deny the user access to the at least one other public cloud infrastructure.

7. The system of claim 5, wherein the usernames and/or IP addresses not matching the stored information are used to deny the user access to virtual desktops across (i) one or more cloud regions in the virtual desktop system, (ii) one or more pool desktops in the virtual desktop system, or (iii) both (i) and (ii).

8. The system of claim 1, wherein subsequent requests for the one or more virtual desktops by the client device application are routed to the public cloud infrastructure, bypassing any actions by the control plane.

9. The system of claim 8, wherein the control plane includes a dedicated gateway control service that provides the obtained information associated with the user and/or the information associated with the client device application to an agent included in the public cloud infrastructure.

10. The system of claim 1, wherein the information associated with the user and/or the information associated with the client device application is stored for a specified period of time.

11. The system of claim 1, wherein the information associated with the user and/or the information associated with the client device application expires after a specified period of time.

12. A method for providing access to a virtual desktop to a user operating a client device, the method comprising:
receiving a request from the client device requesting access to the one or more virtual desktops associated with a public cloud infrastructure;
in response to receiving the request, obtaining, by a control plane, information associated with the user and/or information associated with the client device;
providing the obtained information associated with the user and/or the information associated with the client device to the public cloud infrastructure;
storing the information associated with the client device at the public cloud infrastructure;
comparing usernames and/or IP addresses to the stored information associated with the user and/or the stored information associated with the client device; and
permitting the user access to the one or more virtual desktops in response to the comparison of the usernames and/or IP addresses matching the stored information.

13. The method of claim 12, wherein both the usernames and IP addresses must match with the stored information before the user is permitted access.

14. The method of claim 12, further comprising restricting the user access to the one or more virtual desktops in response to the comparison of the usernames and/or the IP addresses not matching the stored information.

15. The method of claim 14, further comprising performing security analysis on the usernames and/or the IP addresses not matching the stored information.

16. The method of claim 14, further comprising disseminating the usernames and/or IP addresses not matching the stored information to at least one other public cloud infrastructure for a blacklist storage.

17. The method of claim 16, wherein the usernames and/or IP addresses not matching the stored information are used to deny the user access to the at least one other public cloud infrastructure.

18. The method of claim 16, wherein the blacklist storage is used to deny the user access to virtual desktops across (i) one or more cloud regions in the virtual desktop system, (ii) one or more pool desktops in the virtual desktop system, or (iii) both (i) and (ii).

19. The method of claim 12, further comprising routing subsequent requests for the one or more virtual desktops by the client device to the public cloud infrastructure, bypassing any actions by the control plane.

20. The method of claim 12, wherein the information associated with the user and/or the information associated with the client device application is stored for a specified period of time.

21. A non-transitory computer-readable medium having machine-readable instructions stored thereon, which when executed by a processor, cause the processor to:
receive a request from a client device requesting access to one or more virtual desktops associated with a public cloud infrastructure;
in response to receiving the request, obtain, by a control plane, information associated with a user operating the client device and/or information associated with the client device;
provide the obtained information associated with the user and/or the information associated with the client device to the public cloud infrastructure;
store the information associated with the client device at the public cloud infrastructure;
compare usernames and/or IP addresses to the stored information associated with the user and/or the stored information associated with the client device; and
permit the user access to the one or more virtual desktops in response to the comparison of the usernames and/or IP addresses matching the stored information.

22. The non-transitory computer-readable medium of claim 21, wherein both the usernames and IP addresses must match with the stored information before the user is permitted access.

23. The non-transitory computer-readable medium of claim 21, wherein the processor is further caused to restrict the user access to the one or more virtual desktops in response to the comparison of the usernames and/or the IP addresses not matching the stored information.

24. The non-transitory computer-readable medium of claim 23, wherein the processor is further caused to perform security analysis on the usernames and/or the IP addresses not matching the stored information.

25. The non-transitory computer-readable medium of claim 23, wherein the processor is further caused to disseminate the usernames and/or IP addresses not matching the stored information to at least one other public cloud infrastructure for a blacklist storage.

26. The non-transitory computer-readable medium of claim 25, wherein the usernames and/or IP addresses not matching the stored information are used to deny the user access to the at least one other public cloud infrastructure.

27. The non-transitory computer-readable medium of claim 25, wherein the blacklist storage is used to deny the user access to virtual desktops across (i) one or more cloud regions in the virtual desktop system, (ii) one or more pool desktops in the virtual desktop system, or (iii) both (i) and (ii).

28. The non-transitory computer-readable medium of claim 21, wherein the processor is further caused to route subsequent requests for the one or more virtual desktops by the client device to the public cloud infrastructure, bypassing any actions by the control plane.
